(19) United States
(12) Patent Application Publication
(10) Pub. No.: US 2020/0200643 A1
(43) Pub. Date: Jun. 25, 2020

(54) SYSTEM FOR SENSING LEAKS IN A STUFFING BOX

(71) Applicant: PETRÓLEO BRASILEIRO S.A. - PETROBRAS, Rio de Janeiro (BR)

(72) Inventor: Silvio Ferreira Gaglioti, São Mateus (BR)

(73) Assignee: PETRÓLEO BRASILEIRO S.A. - PETROBRAS, Rio de Janeiro (BR)

(21) Appl. No.: 16/608,846

(22) PCT Filed: Apr. 27, 2018
(86) PCT No.: PCT/GB2018/051125

§ 371 Date: Oct. 27, 2019

(30) Foreign Application Priority Data
Apr. 27, 2017 (BR) 10 2017 008806-5

(51) Int. Cl. G01M 3/32; F16J 15/18; E21B 47/00

(52) U.S. Cl. CPC G01M 3/32; E21B 43/127; E21B 47/0008; F16J 15/18

(57) ABSTRACT

A system configured to sense a leak in a stuffing box includes a sensing device that has a support supporting an elongated structure that is configured to pivot relative to the support. A container is fixed to a first end of the elongated structure and is suitable for receiving liquid from a leak. The sensing device includes at least one position sensor for detecting a position of the elongated structure. The system is configured such that when empty, the container remains in a raised position, and a second end of the elongated structure, opposite the first end to which the container is fixed, remains in a lowered position. When the system is filled with leaked liquid, the container moves to a lowered position compared to its empty raised position, and the second end of the elongated structure moves to a relatively raised position compared to its empty lowered position.

### CROSS-REFERENCE TO RELATED APPLICATION

This application claims the benefit of priority to BR 10 2017 008806-5, filed 27 Apr. 2017, which is incorporated herein by reference in its entirety.

### FIELD OF THE INVENTION

The present invention relates to a leak sensor for stuffing boxes.

### BACKGROUND OF THE INVENTION

One of the components of an onshore system for mechanical pumping of petroleum is known as a stuffing box, which is a system consisting of perforated disks (gaskets), generally elastomeric, through which a polished rod slides cyclically.

The function of these disks, or gaskets, is to prevent leakage of fluid to the environment and maintain a confined system pressure. However, as is widely known by a person skilled in the art, these gaskets wear away naturally over time, and when this occurs there is loss of efficiency of the system and leakage of fluids to the surroundings.

Leakage of fluid means serious risks for the environment and for the operators, since the equipment may often reach temperatures above 100° C., with various volatile and potentially toxic products.

Once leakage begins, the process is only stopped when it is noticed by the operators, who then disconnect the equipment to carry out maintenance.

One solution for detecting leaks in stuffing boxes that is known from the prior art consists of a container supported by a spring at the side of the stuffing box, so that when any leak occurs, the container is filled with the fluid until it reaches a defined weight, deforming the spring and activating an electrical contact that indicates to the control system that there is a leak.

However, although the system with a spring is capable of detecting a leak, it is dependent on very precise adjustment between the weight of the container, the coefficient of elasticity of the spring and the weight of the fluid for acceptable operation. Therefore this system is excessively sensitive, and may be affected by many variables. In addition, for the spring to be deformed and for the system to be capable of detecting leaks, generally it is necessary for the volume of oil collected by the container to be very large. Therefore it also takes a long time for a leak to be detected, which may result in negative consequences due to exposure of the operators to the leaked gases.

Another known solution involves a system with a container and a float, in which the leaking fluid is directed to this container so as to lift the float up to a certain point where an electrical contact is activated, indicating to the control system that there is a leak.

Although the system with a float is more sensitive, there is a risk of the float being stuck due to freezing of the fluid, since some fluids change their viscosity drastically on cooling, generating a potential adhesive effect on the float and preventing activation of the leak detecting system.

Some patent documents also disclose various ways of collecting liquid and detecting leaks in stuffing boxes, some of which are presented follow.

Document CN203481001 (U) discloses a structure for collecting leaked liquid that comprises a channel for collecting leaked liquid that directs this liquid to a collecting pipe, which in turn directs the liquid to a collecting container comprising a level sensor, which indicates the existence of a leak.

Document U.S. Pat. No. 5,440,917 (A) discloses a leak detector that can be used in a gasket comprising an absorbent ring with two conductive sheets around the entire internal surface of the ring, a low-voltage power source, a low-voltage lamp, a test switch, and insulated wires.

In that document, the conductive sheets are insulated from one another. However, when there is a leak, the absorbent ring expands due to absorption of leaked liquid, pressing on the conductive sheets so that they come into contact with one another. This contact causes the circuit of the lamp to become “closed”, so that the lamp lights up, indicating the existence of a leak.

Document U.S. Pat. No. 5,148,699 (A) discloses a well head stuffing box that comprises a leak detector installed between the stuffing box and the covering box.

The leak detector in this document operates by directing leaks arising from the stuffing box, through a pipe to a tank that comprises a float that moves up when the level of the fluid in the tank of fluid rises, thus activating a switch that may be used for activating an alarm or for connecting and disconnecting equipment when necessary.

Document U.S. Pat. No. 5,245,860 (A) discloses a method and a device for sensing unacceptable oil leaks in a stuffing box, which includes a tank for receiving the leak divided by a barrier between a first compartment and a second compartment, in which the barrier determines the maximum acceptable level of leakage, so that when the amount of leaked liquid accumulated in the first tank exceeds the defined value, there is leakage of this liquid to the second compartment, which comprises a leak detecting sensor.

Document U.S. Pat. No. 6,592,126 (B2) discloses a mechanical seal assembly that includes a leak detector that collects a leaked liquid and directs it to a container that comprises an optical fibre sensor for detecting when the level of liquid inside it reaches a defined level.

Although the prior art provides various devices and systems for detecting leaks in stuffing boxes, many of them are very susceptible to mechanical faults or depend on complex electronics that may be expensive. As will be described in detail hereunder, the present disclosure provides a simple, low-cost alternative for detecting leaks in stuffing boxes.

### SUMMARY OF THE INVENTION

The present disclosure provides a system for sensing a leak in a stuffing box that has a simple arrangement with little possibility of faults, whether mechanical, electronic or due to freezing of the fluid.

According to a first aspect, there is provided a system configured to sense a leak in a stuffing box, wherein the system comprises a sensing device comprising one or more of: a support supporting an elongated structure, wherein the elongated structure is configured to pivot relative to the support; a container fixed to a first end of the elongated structure, suitable for receiving liquid from a leak; and at least one position sensor suitable for detecting a position of the elongated structure, wherein the system is configured such that: when empty, the container remains in a raised position, and a second end of the elongated structure, opposite the first end to which the container is fixed, remains in a lowered position; and when filled with leaked liquid, the container moves to a lowered position compared to its empty raised position, and the second end of the elongated structure moves to a relatively raised position compared to its empty lowered position.

The support may be in contact with the elongated structure between the two ends thereof.

Optionally the system is positioned in a place where leaked liquid, when present, must necessarily be directed to the container.

The system may further comprise a weight fixed to the second end of the elongated structure.

The system may further comprise two position sensors, one for detecting each of a raised position and a lowered position of the weight. Each of the position sensors may be a lever that actuates a contact when pressed by the weight. The contact may be actuated by at least one of electrical contact, mechanical contact and magnetic contact. Each of the position sensors may be at least one of optical sensor, proximity sensor and mass sensor. The container may be lighter than the weight when empty and heavier than the weight when full of leaked liquid. The at least one position sensor may be suitable for detecting elevation of the weight relative to the container.

The elongated structure may be configured to pivot relative to the support at its centre of mass.

The elongated structure may be configured to pivot relative to the central support on a pivot.

According to a second aspect, there is provided a method of sensing a leak in a stuffing box, the method comprising: using a sensing device comprising a support supporting an elongated structure, wherein the elongated structure is configured to pivot relative to the support; a container fixed to a first end of the elongated structure, suitable for receiving liquid from a leak; and at least one position sensor suitable for detecting a position of the elongated structure, and the method using the at least one position sensor to determine a change in position of the elongated structure and thus a determine the presence of a leak.

According to a third aspect of the disclosure there is provided a system for sensing a leak in a stuffing box having a sensing device that comprises (i) a central support supporting an elongated structure, wherein the elongated structure pivots relative to the central support, (ii) a weight fixed to one end of the elongated structure, (iii) a container fixed to the other end of the elongated structure, opposite the weight, suitable for receiving liquid from a leak, (iv) at least one position sensor suitable for detecting elevation of the weight relative to the container, wherein, when empty, the container remains in a raised position counterbalanced by the weight that remains in a lowered position and, when filled with leaked liquid, the container moves to a lowered position counterbalanced by the weight that moves to a raised position.

According to a fourth aspect, there is provided a system for sensing a leak in a stuffing box, characterized in that it comprises a sensing device comprising: a central support supporting an elongated structure, in which the elongated structure pivots relative to the central support; a weight fixed to one end of the elongated structure; a container fixed to the other end of the elongated structure, opposite the weight, suitable for receiving liquid from a leak; at least one position sensor suitable for detecting elevation of the weight relative to the container, wherein: when empty, the container remains in a raised position counterbalanced by the weight, which remains in a lowered position; and when filled with leaked liquid, the container moves to a lowered position counterbalanced by the weight, which moves to a raised position.

The system may be characterized in that the central support is in contact with the elongated structure between the two ends thereof.

The system may be characterized in that it is positioned in a place where leaked liquid, when present, must necessarily be directed to the container.

The system may be, characterized in that it comprises two position sensors, one for detecting each of the positions of the weight relative to the container.

The system may be characterized in that each of the position sensors is a lever that actuates a contact when pressed by the weight.

The system may be characterized in that the contact is actuated by at least one of electrical contact, mechanical contact and magnetic contact.

The system may be characterized in that each of the position sensors is at least one of optical sensor, proximity sensor and mass sensor.

The system may be characterized in that the elongated structure pivots relative to the central support at its centre of mass.

The system may be characterized in that the container is lighter than the weight when empty and is heavier than the weight when full of leaked liquid.

The system may be characterized in that the elongated structure pivots relative to the central support on a pivot.

### BRIEF DESCRIPTION OF THE FIGURES

The detailed description presented hereunder refers to the appended figures and their respective reference numbers, showing embodiments of the present disclosure.

FIG. 1 illustrates a sectional view of a stuffing box comprising the leak sensing system according to the preferred embodiment of the present disclosure.

FIG. 2 illustrates a schematic view of a sensing device included in the system of the present disclosure in a configuration where a leak has not been detected.

FIG. 3 illustrates a schematic view of a sensing device included in the system of the present disclosure in a position where a leak has already been detected.

### DETAILED DESCRIPTION OF THE INVENTION

First, it is emphasized that the following description will start from a preferred embodiment. As will be obvious to a person skilled in the art, however, the invention is not limited to this particular embodiment.

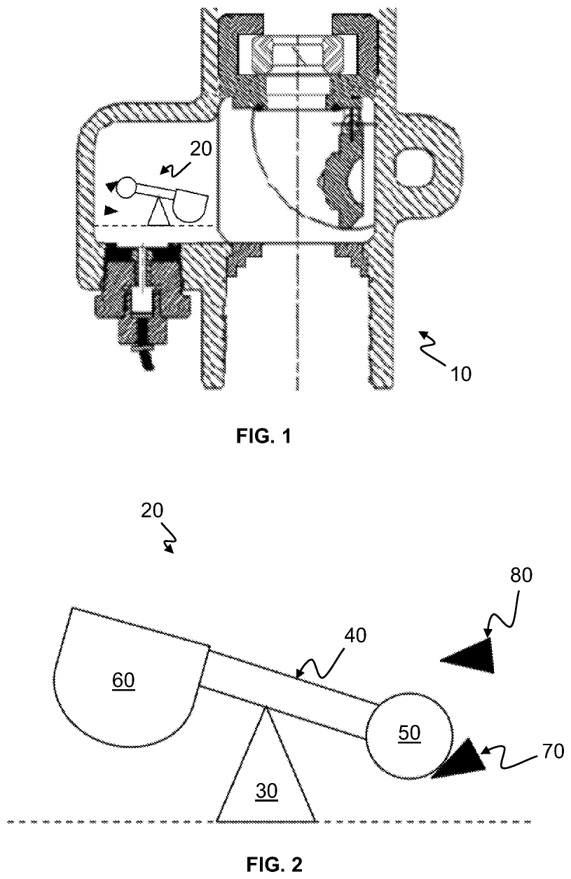

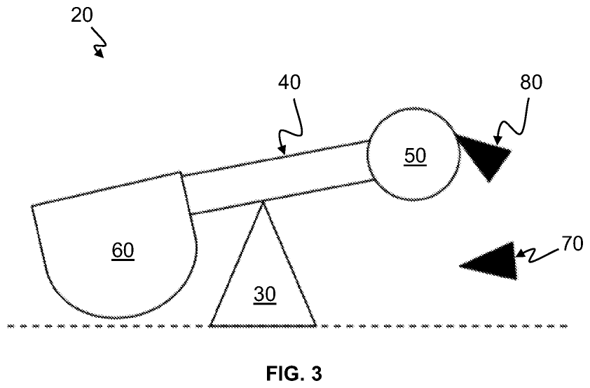

FIG. 1 illustrates a sectional view of a stuffing box 10. The stuffing box 10 comprises a leak sensing system according to a preferred embodiment. As illustrated in FIGS. 2 and 3, the system has a sensing device 20. The sensing device 20 comprises a central support 30. The central support 30 supports an elongated structure 40, such as a bar. The elongated structure 40 can pivot relative to the central support 30. The central support 30 is “central” in that it is positioned between the two ends of the elongated structure 40, but it need not be exactly “central” between the two ends of the elongated structure 40.

As illustrated in any one of FIGS. 1 to 3, the sensing device is in the form of a seesaw. That is, the elongated structure 40 pivots relative to the central support 30. Optionally, the elongated structure 40 pivots relative to the central support 30 at its centre of mass.

Optionally, the elongated structure 40 pivots relative to the central support 30 on a pivot (not shown).

The sensing device 20 can further comprises a weight 50. The weight 50 can be fixed to one end of the elongated structure 40.

At the opposite end of the elongated structure 40, on the other side of the support 30, a container 60 is provided, suitable for receiving liquid from a leak. In an embodiment where the central support 30 supports the elongated structure 40 at its centre of mass, the container 60, when empty, is lighter than the weight 50. When full of leaked liquid, the container 60 is heavier than the weight 50.

Therefore, when empty, the container 60 remains in a raised position counterbalanced by the weight 50, which remains in a lowered position, as illustrated in FIG. 2. When filled with leaked liquid, the container 60 moves to a lower position, relative to its empty raised position, counterbalanced by the weight 50, which moves to a lowered position, relative to the empty raised position as illustrated in FIG. 3. As will be understood, it is not necessary for the container 60 to move from a position that is higher than the weight 50 to a position that is lower than the weight 50 for the sensing device 20 to operate. Whilst a larger movement (e.g. with the container 60 moving from a maximum raised position that the pivot arrangement allows to a minimum lowered position) can provide greater sensitivity, the sensing device 20 can operate based on smaller movements too (e.g. with the container 60 moving from a raised position with respect to the pivot point to a slightly less raised position).

For the system to function most suitably, it is desirable for the sensing device 20 to be positioned in the stuffing box 10 so that any leakage of liquid is directed to the container 60. In this way, the container 60 will be filled as soon as possible, so that the leak is detected.

Preferably, at least one position sensor suitable for detecting a position of the elongated structure 40 is provided. In the depicted embodiment, the position of the elongated structure 40 can be detected by detecting the elevation of the weight 50 relative to the container 60. As illustrated in FIGS. 2 and 3, two position sensors 70, 80 can provided, one each for detecting the high and low positions of the weight 50 relative to the container 60. Thus, when the lower sensor 70 is actuated, for example by contact with the weight 50, it is a signal that there is no leak. Conversely, when the upper sensor 80 is actuated, also by contact with the weight 50, it is a signal that the container is full, indicating a leak.

In the embodiment illustrated in FIGS. 2 and 3, each of the position sensors 70, 80 is a lever that actuates a contact when pressed by the weight 50. The contact actuated can be at least one of an electrical contact, a mechanical contact and a magnetic contact.

It should be emphasized that any type of position sensor may be employed in the present invention, such as an optical sensor, proximity sensor, mass sensor, among others. Moreover, the spacing between the sensors can be varied, to vary the amount of liquid that must be collected before the high position sensor is actuated. This is a way of varying the sensitivity of the sensor. Those skilled in this field would be able to explore any known techniques for determining the position of the weight relative to the container. Thus, this reinforces the fact that the present invention is not limited to the types of sensors listed here.

Although the above discussion has focussed on an embodiment in which a weight 50 is used to counterbalance the container 60, it will be appreciated that other embodiments may not require the weight 50. That is, in some arrangements the weight of the elongated structure 40 may be sufficient to provide the counterbalance. Such arrangements include ones in which the support 30 is not positioned centrally, and is positioned closer to the end of the elongated structure 40 to which the container 60 is attached, or ones in which the elongated structure 40 is not uniform along its length. In such arrangements, the end of the elongated structure 40, rather than the weight, may actuate the position sensors 70, 80, and it is that end which may move from relatively lowered position to a relatively raised position as the container 60 fills with leaked fluid.

In still other arrangements, it may be the container 60 that actuates the at least one position sensor 70, 80, or the at least one position sensor 70, 80 may detect a position of the elongate structure 40 based on the relative position of the container 60 with respect to the weight 50 (or opposite end of the elongated structure 40).

Thus, the present invention provides a system for sensing a leak in a stuffing box comprising a simple arrangement with little possibility of faults, whether mechanical or electronic. This system is not subject to the common faults of the prior art, since it dispenses with the need for precise adjustment of the components and functions independently of freezing of the liquid from a leak.

Countless variations falling within the scope of protection of the present application are permitted. This reinforces the fact that the present invention is not limited to the particular configurations/embodiments described above. As such, modifications of the above-described apparatuses and methods, combinations between different variations as practicable, and variations of aspects of the invention that are obvious to those of skill in the art are intended to be within the spirit and scope of the claims.

1. A system configured to sense a leak in a stuffing box, wherein the system comprises a sensing device comprising:
a support supporting an elongated structure, wherein the elongated structure is configured to pivot relative to the support;
a container fixed to a first end of the elongated structure, suitable for receiving liquid from a leak; and
at least one position sensor suitable for detecting a position of the elongated structure,
wherein the system is configured such that:
when empty, the container remains in a raised position, and a second end of the elongated structure, opposite the first end to which the container is fixed, remains in a lowered position; and
when filled with leaked liquid, the container moves to a lowered position compared to its empty raised position, and the second end of the elongated structure moves to a relatively raised position compared to its empty lowered position.

2. The system according to claim 1, wherein the support is in contact with the elongated structure between the two ends thereof.

3. The system according to claim 1, wherein the system is positioned in a place where leaked liquid, when present, must necessarily be directed to the container.

4. The system according to claim 1, further comprising a weight fixed to the second end of the elongated structure.

5. The system according to claim 4 wherein the system comprises two position sensors, one for detecting each of a raised position and a lowered position of the weight.

6. The system according to claim 5, wherein each of the position sensors is a lever that actuates a contact when pressed by the weight.

7. The system according to claim 6, wherein the contact is actuated by at least one of electrical contact, mechanical contact and magnetic contact.

8. The system according to claim 5, wherein each of the position sensors is at least one of optical sensor, proximity sensor and mass sensor.

9. The system according to claim 4, wherein the container is lighter than the weight when empty and is heavier than the weight when full of leaked liquid.

10. The system according to claim 4, where in the at least one position sensor is suitable for detecting elevation of the weight relative to the container.

11. The system according to claim 1, wherein the elongated structure is configured to pivot relative to the support at its centre of mass.

12. The system according to claim 1, wherein the elongated structure is configured to pivot relative to a central support on a pivot.

13. A method of sensing a leak in a stuffing box, the method comprising:
using a sensing device comprising,
a support supporting an elongated structure, wherein the elongated structure is configured to pivot relative to the support; a container fixed to a first end of the elongated structure, suitable for receiving liquid from a leak; and
at least one position sensor suitable for detecting a position of the elongated structure,
and using the at least one position sensor to determine a change in position of the elongated structure and thus determine the presence of a leak.
